(19) United States
(12) Patent Application Publication
(10) Pub. No.: US 2024/0075617 A1
(43) Pub. Date: Mar. 7, 2024

(54) ROBOT ARM TRAJECTORY CONTROL

(71) Applicant: Applied Materials, Inc., Santa Clara, CA (US)

(72) Inventors: Pei-Chen Wu, Cupertino, CA (US); Rajkumar Thanu, Santa Clara, CA (US); Matvey Farber, Redwood City, CA (US)

(21) Appl. No.: 17/903,916

(22) Filed: Sep. 6, 2022

(51) Int. Cl. B25J 9/16

(52) U.S. Cl. CPC B25J 9/1664; G05B 2219/39001; G05B 2219/40519

(57) ABSTRACT

A method includes identifying a sequence of robot configurations associated with processing a plurality of substrates. The method further includes generating motion planning data comprising corresponding velocity data and corresponding acceleration data for each portion of a trajectory associated with the processing of the plurality of substrates. The method further includes causing a robot arm to be actuated based on the motion planning data.

### TECHNICAL FIELD

The present disclosure relates to trajectory control, and, more particularly, robot arm trajectory control.

### BACKGROUND

Manufacturing equipment transport materials to produce products. For example, substrate processing equipment includes a robot arm that transfers substrates.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

In an aspect of the disclosure, a method includes identifying a sequence of robot configurations associated with processing a plurality of substrates. The method further includes generating motion planning data comprising corresponding velocity data and corresponding acceleration data for each portion of a trajectory associated with the processing of the plurality of substrates. The method further includes causing a robot arm to be actuated based on the motion planning data.

In another aspect of the disclosure, a non-transitory computer-readable storage medium storing instructions which, when executed, cause a processing device to perform operations. The operations include identifying a sequence of robot configurations associated with processing a plurality of substrates. The operations further include generating motion planning data comprising corresponding velocity data and corresponding acceleration data for each portion of a trajectory associated with the processing of the plurality of substrates. The operations further include causing a robot arm to be actuated based on the motion planning data.

In another aspect of the disclosure, a system includes a memory and a processing device coupled to the memory. The processing device is to identify a sequence of robot configurations associated with processing a plurality of substrates. The processing device is further to generate motion planning data comprising corresponding velocity data and corresponding acceleration data for each portion of a trajectory associated with the processing of the plurality of substrates. The processing device is further to cause a robot arm to be actuated based on the motion planning data.

### BRIEF DESCRIPTION OF THE DRAWINGS

The present disclosure is illustrated by way of example, and not by way of limitation in the figures of the accompanying drawings.

FIGS. 1A-C are block diagrams illustrating systems, according to certain embodiments.

FIG. 2 illustrates a data set generator to create data sets for a machine learning model, according to certain embodiments.

FIG. 3 is a block diagram illustrating determining predictive data, according to certain embodiments.

FIGS. 4A-E are flow diagrams of methods associated with robot arm trajectory control, according to certain embodiments.

FIGS. 5A-R illustrate robot arm trajectory control, according to certain embodiments.

FIG. 6 is a block diagram illustrating a computer system, according to certain embodiments.

### DETAILED DESCRIPTION

Described herein are technologies directed to robot arm trajectory control (e.g., motion planning and trajectory optimization with nonlinear optimization, trajectory optimization for Selective Compliance Assembly Robot Arm (SCARA) arm using shortest path planning and nonlinear optimization).

Manufacturing equipment transport materials to produce products. For example, substrate processing equipment includes a robot arm that transfers substrates. A robot arm in the factory interface transfers substrates between substrate carriers, load locks, side storage pods, etc. in the substrate processing system. A robot arm in the transfer chamber transfers substrates between load locks, processing chambers, etc. in the substrate processing system. A substrate is to be transferred between different components in the substrate processing system without colliding with other objects. Throughput of substrates is affected by the speed of the robot arms.

Conventionally, systems receive image data from a camera of the next location for the robot arm to be positioned, determine based on the image data whether the robot arm would collide with an object, and either move the robot arm to the next location (responsive to determining the robot arm would not collide with an object) or wait to move the robot arm to the next location (until the robot arm would not collide with any objects). Obtaining image data, processing the image data, and waiting to move the robot arm until there are no potential collisions can be slow and can take a lot of time, energy, processing overhead, and bandwidth. The time delays can also lead to collision of components. The conventional systems can have damaged substrates, low yield, damaged equipment, and/or the like.

The devices, systems, and methods disclosed herein provide robot arm trajectory control.

A processing device identifies a sequence of robot configurations (e.g., joint angle) associated with processing substrates. A robot arm may include joints that are configured to be actuated in one or more dimensions. Each robot configuration may include a corresponding joint angle for each joint of the robot arm. A robot configuration may position an end effector of the robot arm in a particular location (e.g., load lock chamber, processing chamber, side storage pod, aligner device, local center finder (LCF) device, front opening unified pod (FOUP), etc.). In some embodiments, the sequence is associated with a series of locations (e.g., first location at load lock chamber, second location at a first processing chamber, third at second location processing chamber, final location at load lock chamber)

The processing device generates motion planning data including corresponding velocity data and corresponding acceleration data for each portion of a trajectory associated with the processing of the substrates. In some embodiments, the trajectory is a path between two robot configurations (e.g., that each position the end effector of the robot arm in a corresponding different location) that avoids collision. In some embodiments, the motion planning data includes both state (e.g., position and velocity) and control (e.g., thrust, accelerations) as functions of time. The processing device may minimize distance, time, etc. in generating the motion planning data.

In some embodiments, the corresponding velocity data and the corresponding acceleration data include ramping up (e.g., velocity and/or acceleration) after starting at the starting location and then ramping down (e.g., velocity and/or acceleration) until coming to a stop at the ending location.

The processing device causes a robot arm to be actuated based on the motion planning data. The processing device may provide the motion planning data to a controller to control the robot arm. The processing device causes one or more motors to actuate in one or more dimensions to move the robot arm based on the motion planning data.

Aspects of the present disclosure result in technological advantages. The present disclosure uses less time, energy, processing overhead, and bandwidth than conventional solutions. The present disclosure reduces damaged substrates, increases yield, and decreases damage to equipment compared to conventional solutions.

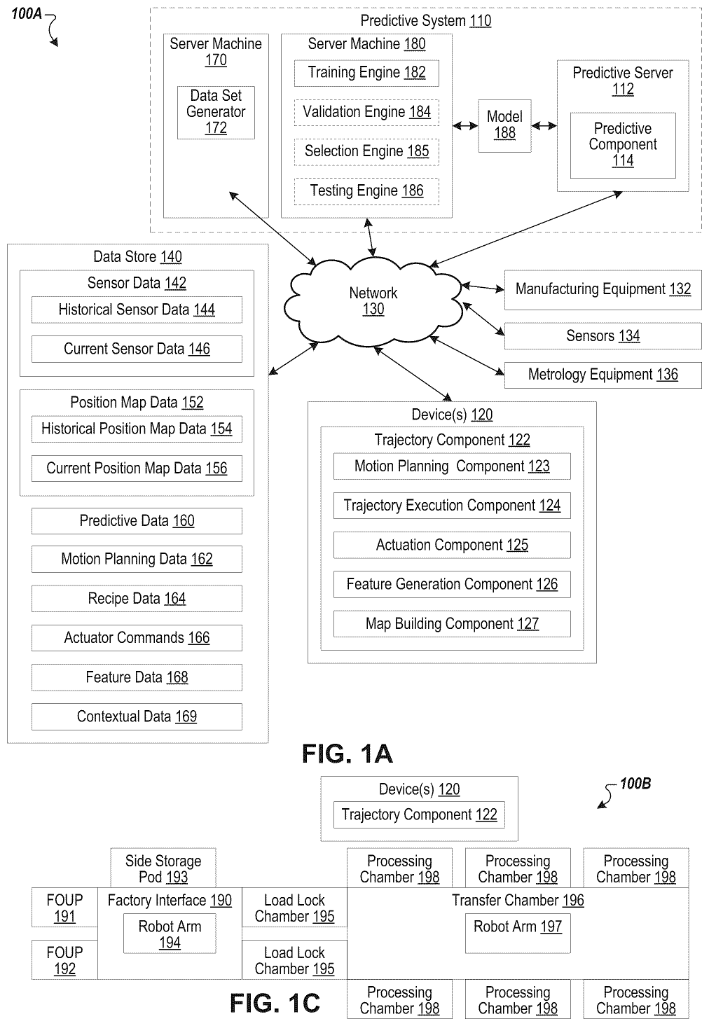

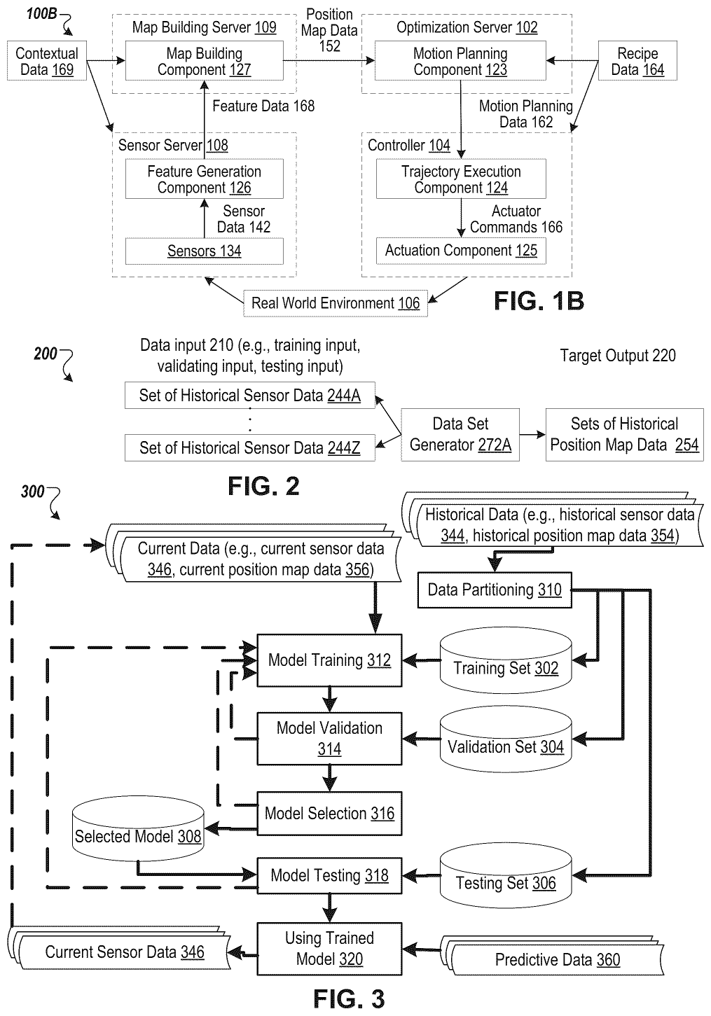

FIGS. 1A-C are block diagrams illustrating systems 100A-C (e.g., exemplary system architecture), according to certain embodiments.

Referring to FIG. 1A, system 100A includes device(s) 120, manufacturing equipment 132, sensors 134, metrology equipment 136, a predictive server 112, and a data store 140. In some embodiments, the predictive server 112 is part of a predictive system 110. In some embodiments, the predictive system 110 further includes server machines 170 and 180.

In some embodiments, at least one of manufacturing equipment 132, sensors 134, metrology equipment 136, predictive server 112, data store 140, one or more of device(s) 120, server machine 170, and/or server machine 180 are coupled to each other via a network 130 for generating predictive data (e.g., predictive data 160 to be used to generate substrates having target performance data 158). In some embodiments, network 130 is a public network that provides device(s) 120 with access to the predictive server 112, data store 140, and other publically available computing devices. In some embodiments, network 130 is a private network that provides device(s) 120 access to manufacturing equipment 132, sensors 134, metrology equipment 136, data store 140, and other privately available computing devices. In some embodiments, network 130 includes one or more Wide Area Networks (WANs), Local Area Networks (LANs), wired networks (e.g., Ethernet network), wireless networks (e.g., an 802.11 network or a Wi-Fi network), cellular networks (e.g., a Long Term Evolution (LTE) network), routers, hubs, switches, server computers, cloud computing networks, and/or a combination thereof.

In some embodiments, the device(s) 120 include a computing device such as Personal Computers (PCs), laptops, mobile phones, smart phones, tablet computers, netbook computers, etc. In some embodiments, the device(s) 120 includes trajectory component 122. In some embodiments, trajectory component 122 include one or more of motion planning component 123, trajectory execution component 124, actuation component 125, feature generation component 126, and/or map building component 127.

Trajectory component 122 may perform trajectory optimization for a robot arm (e.g., SCARA arm) using shortest path planning and non-linear optimization. Trajectory component 122 may perform motion planning and trajectory optimization with non-linear optimization. In some embodiments, trajectory component 122 controls trajectory in robot motion planning to improve throughput (e.g., for vacuum multi-degrees-of-freedom robotic arm). Trajectory component 122 may combine shortest path planning and non-linear optimization. Trajectory component 122 may improve throughput and solve motion planning problems for a robot arm (e.g., distributed actuator SCARA robot) using shortest path planning and non-linear optimization. Trajectory component 122 may define objective function in mathematical form for finding feasible trajectory and incorporate multiple constraints and boundary conditions for optimization. Trajectory component 122 may use shortest path planning in joint space to have a sequence of discrete robot configurations within Cartesian/joint limit for collision avoidance. Trajectory component 122 may apply non-linear optimization (e.g., Broyden-Fletcher-Goldfarb-Shanno (BFGS), limited-memory BFGS for box and/or bound constraints (L-BFGS-B), sequential least squares programming (SLSQP) optimizer, etc.) to generate smooth and continuous trajectory along shortest path within blade acceleration limit and other boundary conditions or constrains when minimizing motor Jerk and/or Torque.

In some embodiments, the trajectory component 122 is included in the predictive system 110 (e.g., machine learning processing system). In some embodiments, the trajectory component 122 is alternatively included in the predictive system 110 (e.g., instead of being included in device(s) 120). Device(s) 120 include an operating system that allows users to one or more of consolidate, generate, view, or edit data, provide directives to the predictive system 110 (e.g., machine learning processing system), etc.

In some embodiments, trajectory component 122 receives user input (e.g., via a Graphical User Interface (GUI) displayed via the device(s) 120) of an indication associated with a robot arm of manufacturing equipment 132 (e.g., sensor data 142, etc.). In some embodiments, the trajectory component 122 transmits the indication to the predictive system 110, receives predictive data 160 from the predictive system 110, determines a corrective action (e.g., updates to the trajectory and/or motion planning data 162) based on the predictive data, and causes the robot arm to be actuated (e.g., based on the corrective action). In some embodiments, the trajectory component 122 obtains position map data 152 associated with the robot arm (e.g., from data store 140, etc.) and provides the position map data 152 to the predictive system 110. In some embodiments, the trajectory component 122 stores data (e.g., sensor data 142, position map data 152, etc.) in the data store 140 and the predictive server 112 retrieves the data from the data store 140. In some embodiments, the predictive server 112 stores output (e.g., predictive data 160) of the trained machine learning model 188 in the data store 140 and the device(s) 120 retrieves the output from the data store 140. In some embodiments, the trajectory component 122 receives an indication of updated motion planning data 162 (e.g., based on predictive data 160) from the predictive system 110 and causes the robot arm to be actuated based on the updated motion planning data 162.

In some embodiments, one or more of device(s) 120, the predictive server 112, server machine 170, and/or server machine 180 each include one or more computing devices such as a rackmount server, a router computer, a server computer, a personal computer, a mainframe computer, a laptop computer, a tablet computer, a desktop computer, Graphics Processing Unit (GPU), accelerator Application-Specific Integrated Circuit (ASIC) (e.g., Tensor Processing Unit (TPU)), etc.

The predictive server 112 includes a predictive component 114. In some embodiments, the predictive component 114 receives sensor data 142 (e.g., receive from the device(s) 120, retrieve from the data store 140) and generates predictive data 160 (e.g., predictive position map data) for determining motion planning data 162. In some embodiments, the predictive component 114 uses one or more trained machine learning models 188 to determine the predictive data for recipe optimization. In some embodiments, trained machine learning model 188 is trained using historical sensor data 144 and historical position map data 154.

In some embodiments, the predictive system 110 (e.g., predictive server 112, predictive component 114) generates predictive data 160 using supervised machine learning (e.g., supervised data set, historical sensor data 144 labeled with historical position map data 154, etc.). In some embodiments, the predictive system 110 generates predictive data 160 using semi-supervised learning (e.g., semi-supervised data set, etc.). In some embodiments, the predictive system 110 generates predictive data 160 using unsupervised machine learning (e.g., unsupervised data set, clustering, etc.).

In some embodiments, the manufacturing equipment 132 (e.g., cluster tool) is part of a substrate processing system (e.g., integrated processing system). The manufacturing equipment 132 includes one or more of a controller (e.g., controller 104 of FIG. 1), an enclosure system (e.g., substrate carrier, FOUP 191 of FIG. 1C, autoteach FOUP, process kit enclosure system, substrate enclosure system, cassette, etc.), a side storage pod (SSP) (e.g., side storage pod 193 of FIG. 1C), an aligner device (e.g., aligner chamber), a factory interface (e.g., equipment front end module (EFEM), factory interface 190 of FIG. 1C), a load lock chamber (e.g., load lock chamber 195 of FIG. 1C), a transfer chamber (e.g., transfer chamber 196 of FIG. 1C), one or more processing chambers (e.g., processing chambers 198 of FIG. 1C), a robot arm (e.g., robot arm disposed in the transfer chamber, disposed in the front interface, robot arm 194 of FIG. 1C, robot arm 197 of FIG. 1C, SCARA arm, etc.), and/or the like. The enclosure system, SSP, and load lock mount to the factory interface and a robot arm disposed in the factory interface is to transfer content (e.g., substrates, process kit rings, carriers, validation wafer, etc.) between the enclosure system, SSP, load lock, and factory interface. The aligner device is disposed in the factory interface to align the content. The load lock chamber and the processing chambers mount to the transfer chamber and a robot arm disposed in the transfer chamber is to transfer content (e.g., substrates, process kit rings, carriers, validation wafer, etc.) between the load lock chamber, the processing chambers, and the transfer chamber. In some embodiments, the sensor data 142 is retrieved during processes performed by components of the manufacturing equipment 132 (e.g., etching, heating, cooling, transferring, processing, flowing, flipping, etc.).

In some embodiments, the sensors 134 provide sensor data 142 associated with manufacturing equipment 132. In some embodiments, the sensors 134 provide sensor values (e.g., historical sensor values, current sensor values). In some embodiments, the sensors 134 include one or more of imaging device (e.g., imaging sensor, camera), force sensor, thrust sensor, velocity sensor, acceleration sensor, distance sensor, torque sensor, Light Detection and Ranging (LIDAR) sensor, pressure sensor, temperature sensor, flow rate sensor, spectroscopy sensor, and/or the like. In some embodiments, the sensor data 142 is received over a period of time.

In some embodiments, sensors 134 provide sensor data 142 such as values of one or more of image data, force data, thrust data, velocity data, acceleration data, distance data, torque data, LIDAR data, leak rate, temperature, pressure, flow rate (e.g., gas flow), pumping efficiency, spacing (SP), High Frequency Radio Frequency (HFRF), electrical current, power, voltage, and/or the like. In some embodiments, sensor data 142 is associated with or indicative of manufacturing parameters such as hardware parameters (e.g., settings or components, such as size, type, etc., of the manufacturing equipment 132) or process parameters of the manufacturing equipment. In some embodiments, sensor data 142 is provided while the manufacturing equipment 132 performs manufacturing processes (e.g., equipment readings when processing or transferring products or components), before the manufacturing equipment 132 performs manufacturing processes, and/or after the manufacturing equipment 132 performs manufacturing processes. In some embodiments, the sensor data 142 is provided while the manufacturing equipment 132 provides a sealed environment (e.g., the diffusion bonding chamber, substrate processing system, and/or processing chamber are closed).

In some embodiments, the sensor data 142 (e.g., historical sensor data 144, current sensor data 146, etc.) is processed (e.g., by the device(s) 120 and/or by the predictive server 112). In some embodiments, processing of the sensor data 142 includes generating features (e.g., feature data 168). In some embodiments, the features are a pattern in the sensor data 142 (e.g., slope, width, height, peak, etc.) or a combination of values from the sensor data 142 (e.g., power derived from voltage and current, etc.). In some embodiments, the sensor data 142 includes features that are used by the predictive component 114 for obtaining predictive data 160.

In some embodiments, the metrology equipment 136 (e.g., imaging equipment, spectroscopy equipment, ellipsometry equipment, etc.) is used to determine metrology data (e.g., inspection data, image data, spectroscopy data, ellipsometry data, material compositional, optical, or structural data, etc.) corresponding to substrates produced by the manufacturing equipment 132 (e.g., substrate processing equipment). In some examples, after the manufacturing equipment 132 processes substrates, the metrology equipment 136 is used to inspect portions (e.g., layers) of the substrates. In some embodiments, the metrology equipment 136 performs scanning acoustic microscopy (SAM), ultrasonic inspection, x-ray inspection, and/or computed tomography (CT) inspection. In some examples, after the manufacturing equipment 132 deposits one or more layers on a substrate, the metrology equipment 136 is used to determine quality of the processed substrate (e.g., thicknesses of the layers, uniformity of the layers, interlayer spacing of the layer, and/or the like). In some embodiments, the metrology equipment 136 includes an imaging device (e.g., SAM equipment, ultrasonic equipment, x-ray equipment, CT equipment, and/or the like).

In some embodiments, the data store 140 is a memory (e.g., random access memory), a drive (e.g., a hard drive, a flash drive), a database system, or another type of component or device capable of storing data. In some embodiments, data store 140 includes multiple storage components (e.g., multiple drives or multiple databases) that span multiple computing devices (e.g., multiple server computers). In some embodiments, the data store 140 stores one or more of sensor data 142, position map data 152, predictive data 160, motion planning data 162, recipe data 164, actuator commands 166, feature data 168, contextual data 169, and/or the like.

Sensor data 142 include historical sensor data 144 and current sensor data 146. In some embodiments, sensor data 142 includes one or more of image data, force data, LIDAR data, distance data, velocity data, acceleration data, pressure data, pressure range, temperature data, temperature range, flow rate data, power data, comparison parameters for comparing inspection data with threshold data, threshold data, cooling rate data, cooling rate range, and/or the like. In some embodiments, the sensor data 142 includes sensor data from sensors 134.

Position map data 152 includes historical position map data 154 and current position map data 156. In some examples, the position map data 152 is indicative of actual locations of one or more components of a substrate processing system (e.g., of manufacturing equipment 132, a robot arm, etc.). In some embodiments, at least a portion of the position map data 152 is based on sensor data 142 from sensors 134. In some embodiments, the position map data 152 includes an indication of an absolute value or a relative value. In some embodiments, the position map data 152 is indicative of meeting a threshold amount of error (e.g., at least 5% error in location, specification limit).

In some embodiments, one or more of device(s) 120 provides position map data 152. In some examples, one or more of device(s) 120 provides position map data 152 that indicates an abnormality in actuation of the robot arm.

In some embodiments, historical data includes one or more of historical sensor data 144 and/or historical position map data 154 (e.g., at least a portion for training the machine learning model 188). Current data includes one or more of current sensor data 146 and/or current position map data 156 (e.g., at least a portion to be input into the trained machine learning model 188 subsequent to training the model 188 using the historical data). In some embodiments, the current data is used for retraining the trained machine learning model 188.

In some embodiments, the predictive data 160 is to be used by one or more of device(s) 120 to actuate robot arm (e.g., update motion planning data 162) of manufacturing equipment 132.

Performing metrology on products to determine incorrectly actuated robot arm is costly in terms of time used, metrology equipment 136 used, energy consumed, bandwidth used to send the metrology data, processor overhead to process the metrology data, etc. By providing sensor data 142 to model 188 and receiving predictive data 160 from the model 188 for producing substrates that meet the target performance data 158, system 100 has the technical advantage of avoiding the costly process of using metrology equipment 136 and discarding substrates associated with incorrectly actuated robot arms.

Performing manufacturing processes (e.g., transporting substrates) that result in defective products is costly in time, energy, products, components, manufacturing equipment 132, etc. By providing sensor data 142, receiving predictive data 160 from the model 188, and updating motion planning data 162 based on the predictive data 160, system 100 has the technical advantage of avoiding the cost of producing, identifying, and discarding defective substrates.

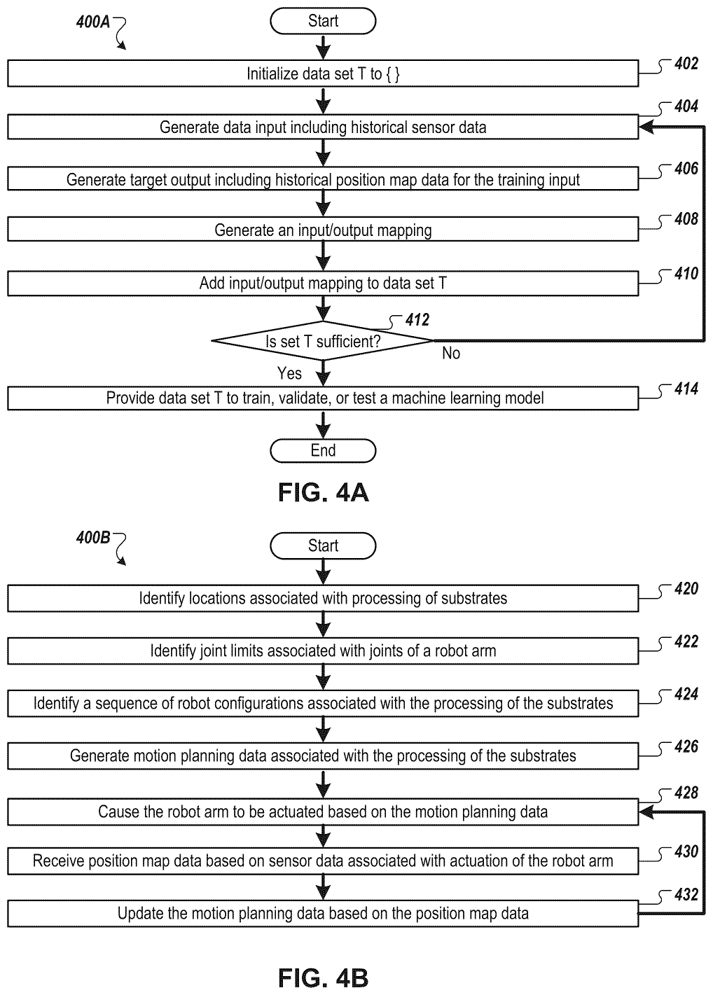

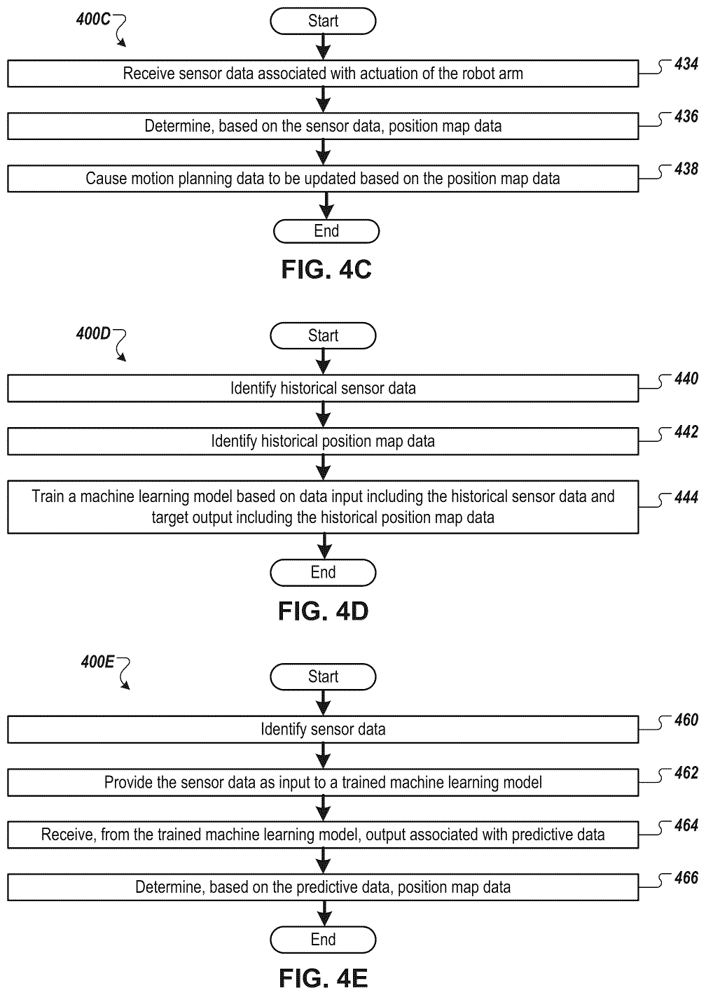

In some embodiments, predictive system 110 further includes server machine 170 and server machine 180. Server machine 170 includes a data set generator 172 that is capable of generating data sets (e.g., a set of data inputs and a set of target outputs) to train, validate, and/or test a machine learning model(s) 188. The data set generator has functions of data gathering, compilation, reduction, and/or partitioning to put the data in a form for machine learning. In some embodiments (e.g., for small datasets), partitioning (e.g., explicit partitioning) for post-training validation is not used. In some embodiments, repeated cross-validation (e.g. 5-fold cross-validation, leave-one-out-cross-validation) is used during training where a given dataset is in-effect repeatedly partitioned into different training and validation sets during training. A model (e.g., the best model, the model with the highest accuracy, etc.) is chosen from vectors of models over automatically-separated combinatoric subsets. In some embodiments, the data set generator 172 explicitly partitions the historical data (e.g., historical sensor data 144 and corresponding historical position map data 154) into a training set (e.g., sixty percent of the historical data), a validating set (e.g., twenty percent of the historical data), and a testing set (e.g., twenty percent of the historical data). In this embodiment, some operations of data set generator 172 are described in detail below with respect to FIGS. 2 and 4A. In some embodiments, the predictive system 110 (e.g., via predictive component 114) generates multiple sets of features (e.g., training features). In some examples a first set of features corresponds to a first set of types of parameters (e.g., from a first set of sensors, first combination of values from first set of sensors, first patterns in the values from the first set of sensors) that correspond to each of the data sets (e.g., training set, validation set, and testing set) and a second set of features correspond to a second set of types of parameters (e.g., from a second set of sensors different from the first set of sensors, second combination of values different from the first combination, second patterns different from the first patterns) that correspond to each of the data sets.

Server machine 180 includes a training engine 182, a validation engine 184, selection engine 185, and/or a testing engine 186. In some embodiments, an engine (e.g., training engine 182, a validation engine 184, selection engine 185, and a testing engine 186) refers to hardware (e.g., circuitry, dedicated logic, programmable logic, microcode, processing device, etc.), software (such as instructions run on a processing device, a general purpose computer system, or a dedicated machine), firmware, microcode, or a combination thereof. The training engine 182 is capable of training a machine learning model 188 using one or more sets of features associated with the training set from data set generator 172. In some embodiments, the training engine 182 generates multiple trained machine learning models 188, where each trained machine learning model 188 corresponds to a distinct set of parameters of the training set (e.g., sensor data 142) and corresponding responses (e.g., position map data 152). In some embodiments, multiple models are trained on the same parameters with distinct targets for the purpose of modeling multiple effects. In some examples, a first trained machine learning model was trained using all parameters, a second trained machine learning model was trained using a first subset of the parameters, and a third trained machine learning model was trained using a second subset of the parameters that partially overlaps the first subset of features.

The validation engine 184 is capable of validating a trained machine learning model 188 using a corresponding set of features of the validation set from data set generator 172. For example, a first trained machine learning model 188 that was trained using a first set of features of the training set is validated using the first set of features of the validation set. The validation engine 184 determines an accuracy of each of the trained machine learning models 188 based on the corresponding sets of features of the validation set. The validation engine 184 evaluates and flags (e.g., to be discarded) trained machine learning models 188 that have an accuracy that does not meet a threshold accuracy. In some embodiments, the selection engine 185 is capable of selecting one or more trained machine learning models 188 that have an accuracy that meets a threshold accuracy. In some embodiments, the selection engine 185 is capable of selecting the trained machine learning model 188 that has the highest accuracy of the trained machine learning models 188.

The testing engine 186 is capable of testing a trained machine learning model 188 using a corresponding set of features of a testing set from data set generator 172. For example, a first trained machine learning model 188 that was trained using a first set of features of the training set is tested using the first set of features of the testing set. The testing engine 186 determines a trained machine learning model 188 that has the highest accuracy of all of the trained machine learning models based on the testing sets.

In some embodiments, the machine learning model 188 (e.g., used for classification) refers to the model artifact that is created by the training engine 182 using a training set that includes data inputs and corresponding target outputs (e.g. correctly classifies a condition or ordinal level for respective training inputs). Patterns in the data sets can be found that map the data input to the target output (the correct classification or level), and the machine learning model 188 is provided mappings that captures these patterns. In some embodiments, the machine learning model 188 uses one or more of Gaussian Process Regression (GPR), Gaussian Process Classification (GPC), Bayesian Neural Networks, Neural Network Gaussian Processes, Deep Belief Network, Gaussian Mixture Model, or other Probabilistic Learning methods. In some embodiments, non-probabilistic methods are used including one or more of Support Vector Machine (SVM), Radial Basis Function (RBF), clustering, Nearest Neighbor algorithm (k-NN), linear regression, random forest, neural network (e.g., artificial neural network), etc. In some embodiments, the machine learning model 188 is a multi-variate analysis (MVA) regression model.

Predictive component 114 provides sensor data 142 to the trained machine learning model 188 and runs the trained machine learning model 188. The predictive component 114 is capable of determining (e.g., extracting) predictive data 160 (e.g., predictive position map data) from output of the trained machine learning model 188 and determines (e.g., extract) uncertainty data that indicates a level of credibility that the predictive data 160 corresponds to position map data 152. In some embodiments, the predictive component 114 and/or trajectory component 122 use the uncertainty data (e.g., uncertainty function or acquisition function derived from uncertainty function) to decide whether to use the predictive data 160 to update motion planning data 162 or whether to further train the model 188.

For purpose of illustration, rather than limitation, aspects of the disclosure describe the training of one or more machine learning models 188 using historical data (i.e. prior data) (e.g., historical sensor data 144 and historical position map data 154) and providing target performance data 158 into the one or more trained probabilistic machine learning models 188 to determine predictive data 160. In other implementations, a heuristic model or rule-based model is used to determine predictive data 160 (e.g., without using a trained machine learning model). In some embodiments, non-probabilistic machine learning models are used. Predictive component 114 monitors historical sensor data 144 and historical position map data 154. In some embodiments, any of the information described with respect to data inputs 210 of FIG. 2 are monitored or otherwise used in the heuristic or rule-based model.

In some embodiments, the functions of device(s) 120, predictive server 112, server machine 170, and server machine 180 are be provided by a fewer number of machines. For example, in some embodiments, server machines 170 and 180 are integrated into a single machine, while in some other embodiments, server machine 170, server machine 180, and predictive server 112 are integrated into a single machine. In some embodiments, device(s) 120 and predictive server 112 are integrated into a single machine.

In general, functions described in one embodiment as being performed by device(s) 120, predictive server 112, server machine 170, and server machine 180 can also be performed on predictive server 112 in other embodiments, if appropriate. In addition, the functionality attributed to a particular component can be performed by different or multiple components operating together. For example, in some embodiments, the predictive server 112 determines updates to the motion planning data 162 based on the predictive data 160. In another example, device(s) 120 receives the predictive data 160 from the trained machine learning model.

In addition, the functions of a particular component can be performed by different or multiple components operating together. In some embodiments, one or more of the predictive server 112, server machine 170, or server machine 180 are accessed as a service provided to other systems or devices through appropriate application programming interfaces (API).

In some embodiments, a “user” is represented as a single individual. However, other embodiments of the disclosure encompass a “user” being an entity controlled by a plurality of users and/or an automated source. In some examples, a set of individual users federated as a group of administrators is considered a “user.”

Although embodiments of the disclosure are discussed in terms of trajectory control of a robot arm in manufacturing facilities (e.g., substrate processing facilities), in some embodiments, the disclosure can also be generally applied to improving trajectories of components. Embodiments can be generally applied to component control based on different types of data.

Referring to FIG. 1B, system 100B is associated with robot arm trajectory control. System 100B may be a substrate processing system (e.g., manufacturing equipment 132. The system 100 may include one or more devices 120 that are used to control one or more components of system 100B.

In some embodiments, system 100 includes a factory interface 190 that includes a robot arm 194 (e.g., SCARA arm). One or more FOUPs 191 (e.g., substrate carriers), load ports, side storage pods 193, and/or load lock chambers 195 may be coupled (e.g., attached, docked, fastened, etc.) to factory interface 190.

In some embodiments, system 100C includes a transfer chamber 196 that includes a robot arm 197 (e.g., SCARA arm). One or more load lock chambers 195 and/or processing chambers 198 may be coupled (e.g., attached, docked, fastened, etc.) to transfer chamber 196.

Trajectory component 122 (e.g., motion planning component 123) executed by one or more device(s) 120 may be used to generate motion planning data 162 to control robot arm 197 of transfer chamber 196 and/or robot arm 194 of factory interface 190.

Referring to FIG. 1C, system 100C is associated with robot arm trajectory control.

In some embodiments, the one or more device(s) 120 of FIG. 1A include one or more of optimization server 102, controller 104, sensor server 108, and/or map building server 109. In some embodiments, one or more of optimization server 102, controller 104, sensor server 108, and/or map building server 109 are combined into the same device (e.g., server).

In some embodiments, functionality of the trajectory component 122 of FIG. 1A is spread across two or more of the one or more device(s) 120. In some embodiments, functionality of the trajectory component 122 of FIG. 1A includes one or more of motion planning component 123, trajectory execution component 124, actuation component 125, feature generation component 126, and/or map building component 127. In some embodiments, the optimization server 102 includes motion planning component 123, controller 104 includes trajectory execution component 124 and actuation component 125, sensor server 108 includes feature generation component 126, and map building server 109 includes map building component 127. In some embodiments, sensor server 108 includes sensors 134.

The optimization server 102 (e.g., via motion planning component 123) may receive recipe data 164 and may generate motion planning data 162 (e.g., via method 400B of FIG. 4B). In some embodiments, the recipe data 164 includes locations of components of the substrate processing system (e.g., locations of the manufacturing equipment 132, locations of the load lock chambers 195 of FIG. 1C and the processing chambers 198 of FIG. 1C). In some embodiments, the recipe data 164 includes joint limits (e.g., dimensions, allowable joint angle ranges) of the joints of the robot arm of the manufacturing equipment 132. In some embodiments, the recipe data 164 includes a sequence of locations in the substrate processing system for performing substrate processing (e.g., first in load lock chamber, then in a first processing chamber, then in a second processing chamber, and finally in load lock chamber).

The motion planning data 162 may include a corresponding velocity and a corresponding acceleration at each portion of a trajectory of the robot arm (e.g., path following the sequence of locations) as a function of time. In some examples, the motion planning data 162 indicates a first robot configuration (e.g., joint angle, location, state), first velocity, and first acceleration at a first point in time and indicates a second robot configuration (e.g., joint angle, location, state), second velocity, and second acceleration at a second point in time. The motion planning component 123 may generate the motion planning data 162 by minimizing the distance and/or time to perform the sequence of robot configurations (e.g., obtain substrate, move substrate to a particular sequence of components of the substrate processing system, and provide substrate).

The controller 104 (e.g., of the robot arm, of the substrate processing equipment, etc.) receives the motion planning data 162 and generates (e.g., via trajectory execution component 124) actuator commands 166. The controller 104 uses the actuator commands 166 to actuate (e.g., via actuation component 125) the robot arm based on the motion planning data 162.

The robot arm is actuated in the real world environment 106 (e.g., in the substrate processing system, in the manufacturing equipment 132).

Sensors 132 provide sensor data 142 measured while the robot arm was actuated in real world environment 106. In some embodiments, feature generation component 126 generates feature data 168 (e.g., features) based on the sensor data 142. In some embodiments, feature generation component 126 generates the feature data 168 further based on contextual data 169 (e.g., subject matter expertise). Contextual data 169 may indicate features (e.g., slopes, frequencies, threshold values, combination of values, etc.) of sensor data 142 that are to be used to generate feature data 168.

Map building server 109 receives the feature data 168 (e.g., or sensor data 142) and generates position map data 152 (e.g., via map building component 127, via method 400C of FIG. 4C). In some embodiments, map building server 109 further generates position map data 152 based on contextual data 169 (e.g., subject matter expertise, relations between position map data 152 and sensor data 142 or feature data 168).

In some embodiments, the positon map data 152 is indicative of actual locations of the robot arm and/or one or more components in the substrate processing system (e.g., manufacturing equipment 132) and the motion planning data 162 is based on predicted locations of the robot arm and/or one or more components in the substrate processing system.

The optimization server 102 receives the position map data 152 and updates (e.g., via motion planning component 123) the motion planning data 162 based on the position map data 152. The position map data 152 may be used to calibrate the generation of motion planning data 162 by the motion planning component 123.

FIG. 2 illustrates a data set generator 272 (e.g., data set generator 172 of FIG. 1A) to create data sets for a machine learning model (e.g., model 188 of FIG. 1A), according to certain embodiments. In some embodiments, data set generator 272 is part of server machine 170 of FIG. 1A. In some embodiments, the data sets generated by data set generator 272 of FIG. 2 are used to train a machine learning model of the present disclosure.

Data set generator 272 (e.g., data set generator 172 of FIG. 1A) creates data sets for a machine learning model (e.g., model 188 of FIG. 1A). Data set generator 272 creates data sets using historical sensor data 244 (e.g., historical sensor data 144 of FIG. 1A) and historical position map data 254 (e.g., historical position map data 154 of FIG. 1A). System 200 of FIG. 2 shows data set generator 272, data inputs 210, and target output 220 (e.g., target data).

In some embodiments, data set generator 272 generates a data set (e.g., training set, validating set, testing set) that includes one or more data inputs 210 (e.g., training input, validating input, testing input) and one or more target outputs 220 that correspond to the data inputs 210. The data set also includes mapping data that maps the data inputs 210 to the target outputs 220. Data inputs 210 are also referred to as “features,” “attributes,” or information.” In some embodiments, data set generator 272 provides the data set to the training engine 182, validating engine 184, or testing engine 186, where the data set is used to train, validate, or test the machine learning model 188. Some embodiments of generating a training set are further described with respect to FIG. 4A.

In some embodiments, data set generator 272 generates the data input 210 and target output 220. In some embodiments, data inputs 210 include one or more sets of historical sensor data 244. In some embodiments, historical sensor data 244 include one or more of parameters from one or more types of sensors, combination of parameters from one or more types of sensors, patterns from parameters from one or more types of sensors, and/or the like.

In some embodiments, data set generator 272 generates a first data input corresponding to a first set of historical sensor data 244A to train, validate, or test a first machine learning model and the data set generator 272 generates a second data input corresponding to a second set of historical sensor data 244B to train, validate, or test a second machine learning model.

In some embodiments, the data set generator 272 discretizes (e.g., segments) one or more of the data input 210 or the target output 220 (e.g., to use in classification algorithms for regression problems). Discretization (e.g., segmentation via a sliding window) of the data input 210 or target output 220 transforms continuous values of variables into discrete values. In some embodiments, the discrete values for the data input 210 indicate discrete historical sensor data 244 to obtain a target output 220 (e.g., discrete historical position map data 254).

Data inputs 210 and target outputs 220 to train, validate, or test a machine learning model include information for a particular facility (e.g., for a particular substrate manufacturing facility). In some examples, historical sensor data 244 and historical position map data 254 are for the same manufacturing facility.

In some embodiments, the information used to train the machine learning model is from specific types of manufacturing equipment 132 of the manufacturing facility having specific characteristics and allow the trained machine learning model to determine outcomes for a specific group of manufacturing equipment 132 based on input for current parameters (e.g., current sensor data 146) associated with one or more components sharing characteristics of the specific group. In some embodiments, the information used to train the machine learning model is for components from two or more manufacturing facilities and allows the trained machine learning model to determine outcomes for components based on input from one manufacturing facility.

In some embodiments, subsequent to generating a data set and training, validating, or testing a machine learning model 188 using the data set, the machine learning model 188 is further trained, validated, or tested (e.g., with current position map data 156 of FIG. 1A) or adjusted (e.g., adjusting weights associated with input data of the machine learning model 188, such as connection weights in a neural network).

FIG. 3 is a block diagram illustrating a system 300 for generating predictive data 360 (e.g., predictive data 160 of FIG. 1A), according to certain embodiments. The system 300 is used to determine predictive data 360 via a trained machine learning model (e.g., model 188 of FIG. 1A) to control actuation of a robot arm (e.g., for production of substrates with manufacturing equipment 132).

At block 310, the system 300 (e.g., predictive system 110 of FIG. 1A) performs data partitioning (e.g., via data set generator 172 of server machine 170 of FIG. 1A) of the historical data (e.g., historical sensor data 344 and historical position map data 354 for model 188 of FIG. 1A) to generate the training set 302, validation set 304, and testing set 306. In some examples, the training set is 60% of the historical data, the validation set is 20% of the historical data, and the testing set is 20% of the historical data. The system 300 generates a plurality of sets of features for each of the training set, the validation set, and the testing set. In some examples, if the historical data includes features derived from parameters from 20 sensors (e.g., sensors 134 of FIG. 1A) and 100 positions (e.g., positions of the robot arm that each correspond to the parameters from the 20 sensors), a first set of features is sensors 1-10, a second set of features is sensors 11-20, the training set is positions 1-60, the validation set is positions 61-80, and the testing set is positions 81-100. In this example, the first set of features of the training set would be parameters from sensors 1-10 for positions 1-60.

At block 312, the system 300 performs model training (e.g., via training engine 182 of FIG. 1A) using the training set 302. In some embodiments, the system 300 trains multiple models using multiple sets of features of the training set 302 (e.g., a first set of features of the training set 302, a second set of features of the training set 302, etc.). For example, system 300 trains a machine learning model to generate a first trained machine learning model using the first set of features in the training set (e.g., parameters from sensors 1-10 for positions 1-60) and to generate a second trained machine learning model using the second set of features in the training set (e.g., parameters from sensors 11-20 for positions 1-60). In some embodiments, the first trained machine learning model and the second trained machine learning model are combined to generate a third trained machine learning model (e.g., which is a better predictor than the first or the second trained machine learning model on its own in some embodiments). In some embodiments, sets of features used in comparing models overlap (e.g., first set of features being parameters from sensors 1-15 and second set of features being sensors 5-20). In some embodiments, hundreds of models are generated including models with various permutations of features and combinations of models.

At block 314, the system 300 performs model validation (e.g., via validation engine 184 of FIG. 1A) using the validation set 304. The system 300 validates each of the trained models using a corresponding set of features of the validation set 304. For example, system 300 validates the first trained machine learning model using the first set of features in the validation set (e.g., parameters from sensors 1-10 for positions 61-80) and the second trained machine learning model using the second set of features in the validation set (e.g., parameters from sensors 11-20 for positions 61-80). In some embodiments, the system 300 validates hundreds of models (e.g., models with various permutations of features, combinations of models, etc.) generated at block 312. At block 314, the system 300 determines an accuracy of each of the one or more trained models (e.g., via model validation) and determines whether one or more of the trained models has an accuracy that meets a threshold accuracy. Responsive to determining that none of the trained models has an accuracy that meets a threshold accuracy, flow returns to block 312 where the system 300 performs model training using different sets of features of the training set. Responsive to determining that one or more of the trained models has an accuracy that meets a threshold accuracy, flow continues to block 316. The system 300 discards the trained machine learning models that have an accuracy that is below the threshold accuracy (e.g., based on the validation set).

At block 316, the system 300 performs model selection (e.g., via selection engine 185 of FIG. 1A) to determine which of the one or more trained models that meet the threshold accuracy has the highest accuracy (e.g., the selected model 308, based on the validating of block 314). Responsive to determining that two or more of the trained models that meet the threshold accuracy have the same accuracy, flow returns to block 312 where the system 300 performs model training using further refined training sets corresponding to further refined sets of features for determining a trained model that has the highest accuracy.

At block 318, the system 300 performs model testing (e.g., via testing engine 186 of FIG. 1A) using the testing set 306 to test the selected model 308. The system 300 tests, using the first set of features in the testing set (e.g., parameters from sensors 1-10 for positions 81-100), the first trained machine learning model to determine the first trained machine learning model meets a threshold accuracy (e.g., based on the first set of features of the testing set 306). Responsive to accuracy of the selected model 308 not meeting the threshold accuracy (e.g., the selected model 308 is overly fit to the training set 302 and/or validation set 304 and is not applicable to other data sets such as the testing set 306), flow continues to block 312 where the system 300 performs model training (e.g., retraining) using different training sets corresponding to different sets of features (e.g., parameters from different sensors). Responsive to determining that the selected model 308 has an accuracy that meets a threshold accuracy based on the testing set 306, flow continues to block 320. In at least block 312, the model learns patterns in the historical data to make predictions and in block 318, the system 300 applies the model on the remaining data (e.g., testing set 306) to test the predictions.

At block 320, system 300 uses the trained model (e.g., selected model 308) to receive current sensor data 346 (e.g., current sensor data 146 of FIG. 1A) and determines (e.g., extracts), from the trained model, predictive data 360 (e.g., predictive position map data, predictive data 160 of FIG. 1A) to update motion planning data 162 for trajectory control of the robot arm. In some embodiments, the current sensor data 346 corresponds to the same types of features in the historical sensor data 344. In some embodiments, the current sensor data 346 corresponds to a same type of features as a subset of the types of features in historical sensor data 344 that is used to train the selected model 308.

In some embodiments, current data is received. In some embodiments, current data includes current position map data 356 (e.g., current position map data 156 of FIG. 1A) and/or current sensor data 346. In some embodiments, the current data is received from sensors or via user input. The model 308 is re-trained based on the current data. In some embodiments, a new model is trained based on the current position map data 356 and the current sensor data 346.

In some embodiments, one or more of the blocks 310-320 occur in various orders and/or with other operations not presented and described herein. In some embodiments, one or more of blocks 310-320 are not be performed. For example, in some embodiments, one or more of data partitioning of block 310, model validation of block 314, model selection of block 316, and/or model testing of block 318 are not be performed.

FIGS. 4A-E are flow diagrams of methods 400A-E associated with robot arm trajectory control, according to certain embodiments. In some embodiments, methods 400A-E are performed by processing logic that includes hardware (e.g., circuitry, dedicated logic, programmable logic, microcode, processing device, etc.), software (such as instructions run on a processing device, a general purpose computer system, or a dedicated machine), firmware, microcode, or a combination thereof. In some embodiments, methods 400A-E are performed, at least in part, by predictive system 110.

In some embodiments, method 400A is performed, at least in part, by predictive system 110 (e.g., server machine 170 and data set generator 172 of FIG. 1A, data set generator 272 of FIG. 2). In some embodiments, predictive system 110 uses method 400A to generate a data set to at least one of train, validate, or test a machine learning model.

In some embodiments, method 400B is performed by one or more device(s) 120 (e.g., trajectory component 122, optimization server 102, motion planning component 123). In some embodiments, method 400C is performed by one or more device(s) 120 (e.g., trajectory component 122, map building server 109, map building component 127).

In some embodiments, method 400D is performed by server machine 180 (e.g., training engine 182, etc.). In some embodiments, method 400E is performed by predictive server 112 (e.g., predictive component 114).

In some embodiments, a non-transitory storage medium stores instructions that when executed by a processing device (e.g., of predictive system 110, of server machine 180, of predictive server 112, of one or more device(s) 120, etc.), cause the processing device to perform one or more of methods 400A-E.

For simplicity of explanation, methods 400A-E are depicted and described as a series of operations. However, operations in accordance with this disclosure can occur in various orders and/or concurrently and with other operations not presented and described herein. Furthermore, in some embodiments, not all illustrated operations are performed to implement methods 400A-E in accordance with the disclosed subject matter. In addition, those skilled in the art will understand and appreciate that methods 400A-E could alternatively be represented as a series of interrelated states via a state diagram or events.

FIG. 4A is a flow diagram of a method 400A for generating a data set for a machine learning model for generating predictive data (e.g., predictive data 160 of FIG. 1A), according to certain embodiments.

Referring to FIG. 4A, in some embodiments, at block 402 the processing logic implementing method 400A initializes a training set T to an empty set.

At block 404, processing logic generates first data input (e.g., first training input, first validating input) that includes sensor data (e.g., historical sensor data 144 of FIG. 1A, historical sensor data 244 of FIG. 2, etc.). In some embodiments, the first data input includes a first set of features for types of sensor data and a second data input includes a second set of features for types of sensor data (e.g., as described with respect to FIG. 2).

At block 406, processing logic generates a first target output for one or more of the data inputs (e.g., first data input). In some embodiments, the first target output is historical position map data (e.g., historical position map data 154 of FIG. 1A, historical position map data 254 of FIG. 2).

At block 408, processing logic optionally generates mapping data that is indicative of an input/output mapping. The input/output mapping (or mapping data) refers to the data input (e.g., one or more of the data inputs described herein), the target output for the data input (e.g., where the target output identifies historical position map data 154), and an association between the data input(s) and the target output.

At block 410, processing logic adds the mapping data generated at block 408 to data set T.

At block 412, processing logic branches based on whether data set T is sufficient for at least one of training, validating, and/or testing machine learning model 188 (e.g., uncertainty of the trained machine learning model meets a threshold uncertainty). If so, execution proceeds to block 414, otherwise, execution continues back to block 404. It should be noted that in some embodiments, the sufficiency of data set T is determined based simply on the number of input/output mappings in the data set, while in some other implementations, the sufficiency of data set T is determined based on one or more other criteria (e.g., a measure of diversity of the data examples, accuracy, etc.) in addition to, or instead of, the number of input/output mappings.

At block 414, processing logic provides data set T (e.g., to server machine 180) to train, validate, and/or test machine learning model 188. In some embodiments, data set T is a training set and is provided to training engine 182 of server machine 180 to perform the training. In some embodiments, data set T is a validation set and is provided to validation engine 184 of server machine 180 to perform the validating. In some embodiments, data set T is a testing set and is provided to testing engine 186 of server machine 180 to perform the testing. In the case of a neural network, for example, input values of a given input/output mapping (e.g., numerical values associated with data inputs 210) are input to the neural network, and output values (e.g., numerical values associated with target outputs 220) of the input/output mapping are stored in the output nodes of the neural network. The connection weights in the neural network are then adjusted in accordance with a learning algorithm (e.g., back propagation, etc.), and the procedure is repeated for the other input/output mappings in data set T.

After block 414, machine learning model (e.g., machine learning model 188) can be at least one of trained using training engine 182 of server machine 180, validated using validating engine 184 of server machine 180, or tested using testing engine 186 of server machine 180. The trained machine learning model is implemented by predictive component 114 (of predictive server 112) to generate predictive data (e.g., predictive data 160) for robot arm trajectory control.

FIG. 4B is a method 400B associated with robot arm trajectory control, according to certain embodiments.

At block 420 of method 400B, processing logic identifies locations associated with processing of substrates. The processing logic may identify the locations based on recipe data (e.g., recipe data 164 of FIG. 1). In some embodiments, the locations include locations of one or more load lock chambers (e.g., load lock chambers 195 of FIG. 1C), one or more processing chambers (e.g., processing chambers 198 of FIG. 1C), one or more side storage pods (e.g., side storage pod 193 of FIG. 1C), and/or one or more substrate carriers (e.g., FOUPs 191). In some embodiments, the locations are in reference to a reference point (e.g., of the robot arm). In some embodiments, the locations are in Cartesian coordinates. In some embodiments, the locations are robot configurations (e.g., joint angles of the joints of the robot arm, height of the end effector of the robot arm, etc.).

At block 422, processing logic identifies joint limits associated with joints of a robot arm. In some embodiments, the join limits are angle ranges to which that each of the joints of the robot arm can rotate. In some embodiments, the processing logic identifies vertical ranges of one or more portions of the robot arm (e.g., of the joints, of the end effector, etc.).

In some embodiments, the processing logic performs path planning (e.g., A* path planning, RRT path planning, RRT* path planning, D* path planning, etc.) in joint space with D dimensional motion planning. In some embodiments, for a threshold amount of degrees of freedom (e.g., higher dimensional planning, such as 7 degrees of freedom robot arm), RRT and RRT* may be more efficient and/or feasible. The processing logic may use non-linear optimization may be used for generating trajectory (e.g., on any path in both joint and Cartesian spaces). In some embodiments, an action at each joint of the robot arm is [+r,0,−r], where:
r is the angle of resolution;
total number of neighbors at the current configuration is 3^{D};
Δq=q′−q;
Δq′=q_{goal}−q′;
q∈[0,2π];
q′ is next state;
q is current state; and

Heuristic cost=cost to arrive+∥min(2π−Δq,Δq)∥₂+∥min(2π−Δq′,Δq′)∥₂;

At block 424, processing logic identifies a sequence of robot configurations associated with the processing of the substrates. In some embodiments, the robot configurations include joint angles and/or one or more heights. In some examples, the sequence of robot configurations includes a robot configuration of three joint angles and a height for an initial state of the robot arm (e.g., at the load lock chamber), a robot configuration of three joint angles and a height for a subsequent state of the robot arm (e.g., at a processing chamber), etc. In some embodiments, the processing logic determines a sequence of robot configurations (q), where: q∈R^{D} is robot configuration, such as joint angles.

At block 426, processing logic generates motion planning data associated with the processing of the substrates. In some embodiments, the processing logic generates the motion planning data based on one or more of the locations of block 420, the joint limits of block 422, recipe data 164 of FIG. 1B, position map data 152 of FIG. 1B, etc. In some embodiments, the motion planning data includes a trajectory of the robot arm from one location to the next of the locations of block 420. In some embodiments, the motion planning data includes a corresponding robot configuration, a corresponding velocity, and a corresponding acceleration at each portion of the trajectory of the robot arm. In some embodiments, the processing logic generates the motion planning data by minimizing the time and/or distance to travel the trajectory by the robot arm while avoiding collisions.

In some embodiments, processing logic generates motion planning data (e.g., performs trajectory generation) via nonlinear optimization. The processing logic initializes the state on a path (e.g., A* path). The processing logic applies a method (e.g., Nelder-Mead, L-BFGS-B, Powell, TNC, constrained optimization by linear approximation (COBYLA), SLSQP, trust-constr, etc.) to minimize the objective function subject to several equality and inequality constraints within boundary conditions and constraints.

The processing logic determines robot configuration (q), velocity (\dot{q}), and acceleration (\ddot{q}) at each portion (e.g., time step), where q, \dot{q}, \ddot{q}∈R^{D}.

In some embodiments, the processing logic uses objective cost functions to generate the motion planning data.

In some embodiments, an objective cost function includes:

min∫₀^{tf}distdt

In some embodiments, an objective cost function includes:

min∫₀^{tf}Σ_{d=1}^{D}u_{d}²+distdt

In some embodiments, an objective cost function includes:

min∫₀^{tf}Σ_{d=1}^{D}u_{d}²+distdt+t_{f}

In some embodiments, an objective cost function includes:

min∫₀^{tf}distdt+t_{f}

In some embodiments, the processing logic is subject to one or more of the following equality and inequality constraints:

u≡Torque

x=[q₁,q₂, . . . q_{D},\dot{q}₁,\dot{q}₂, . . . \dot{q}_{D}]; and/or

u=[u₁,u₂, . . . u_{D}].

In some embodiments, the processing logic is subject to one or more of the following equality and inequality constraints:

u≡Jerk;

x=[q₁,q₂, . . . q_{D},\dot{q}₁,\dot{q}₂, . . . \dot{q}_{D},\ddot{q}₁,\ddot{q}₂, . . . ,\ddot{q}_{D}]; and/or

u=[u₁,u₂, . . . u_{D}].

The processing logic may have one or more of the following boundary constraints:

x∈X; and/or

u∈U, where:
U can be actuation limit, jerk limit, etc.; and
X can be joint angle, velocity, acceleration limit, etc.

The processing logic may have one or more of the following dynamic and kinematic constraints:

\dot{x}=f(x,u); and/or

xₖ₊₁=xₖ+dt*f(xₖ,uₖ)

The processing logic may have the following boundary condition:

x₀=xₛₜₐᵣₜ;

x_{f}=x_{goal};

FD(x₀,u₀)=0;

FD(x_{f},u_{f})=0.

The processing logic may use slew rate constraint or jerk constraint on both robot end effector (EEF) and motors. Setting Acceleration (Acc) and Jerk constraint on EEF may make robot EEF move along A* collision avoidance path within Acc and Jerk limit. The processing logic (e.g., nonlinear optimizer) may push each motor jerk to a value that meets a threshold value (e.g., a very high value) to achieve a threshold acceleration value (e.g., maximum acceleration) on the robot EEF (e.g., as soon as possible).

The processing logic may have one or more of the following slew rate constraints:
For u=torque,

[FK(xₖ₊₁,FD(xₖ₊₁,uₖ₊₁))−FK(xₖ,FD(xₖ,uₖ))]/dt≤Wafer Jerk Limit,

[FD(xₖ₊₁,uₖ₊₁)−FD(xₖ,uₖ)]/dt≤Motor Jerk Limit; and/or
For u=jerk,

[FK(xₖ₊₁)−FK(xₖ)]/dt≤Wafer Jerk Limit,

[(xₖ₊₁(acc))−(xₖ(acc))]/dt≤Motor Jerk Limit.

The processing logic may have one or more of the following acceleration constraints (e.g., EEF acceleration constraints) (slew rate constraint may be added for the acceleration calculated by forward dynamics):

FK(x,FD(x,u))≤Wafer Accel Limit; and/or

FK(x)≤Wafer Accel Limit.

The processing logic may have one or more of the following power constraints:

Σ_{d=1}^{D}u_{d}*ω_{d}+I_{d}²*R*C≤Power Limit, where I=u/Kₜ; and/or

Σ_{d=1}^{D}T_{d}*ω_{d}+I_{d}²*R*C≤Power Limit, where T=ID(x) and I=T/Kₜ.

In some embodiments, the processing logic calculates the distance using the following:

dist=[Σₜ₌₀^{N}(∥qᵢ−qᵢ*∥₂)²]^{1/2}, where:
q∈R^{D};
q*∈A*;
N is the number of trajectory segments;
IK is the Inverse Kinematic;
FK is the Forward Kinematic;
ID is the Inverse Dynamic;
FD is the Forward Dynamic;
Kₜ is the Torque Constant;
C is the Constant;
R is Motor Resistance; and/or
ω is angular Velocity.

At block 428, processing logic causes a robot arm to be actuated based on the motion planning data.

In some embodiments, the processing logic is to cause the trajectory tracking controller (e.g., proportional-integral-derivative (PID), linear-quadratic regulator (LQR), iterative LQR (iLQR), model predictive control (MPC), etc.) to be actuated (e.g., considering the optimized trajectory as the nominal trajectory to track).

At block 430, processing logic receives position map data that is based on sensor data associated with the actuation of the robot arm. The position map data may be calculated using one or more of FIGS. 4C-E. The motion planning data may use predicted values (e.g., locations, force values, velocity data, acceleration data, robot configuration, etc.) and the position map data may be actual values.

At block 432, processing logic updates the motion planning data based on the position map data. The position map data may be used to calibrate the motion planning data. Flow returns to block 428 (e.g., to cause the robot arm to be actuated based on the updated motion planning data from block 432). Blocks 428-432 may be repeated until the updates to the position map data is below a threshold amount.

FIG. 4C is a method 400C associated with robot arm trajectory control, according to certain embodiments.

At block 434 of method 400C, processing logic receives sensor data associated with actuation of a robot arm (e.g., actuation caused by block 428 of FIG. 4B). The sensor data may include image data, force data, velocity data, acceleration data, distance data, location data, etc. In some embodiments, the sensor data is feature data (e.g., features) based on raw data received from the sensors (e.g., and subject matter expertise). In some embodiments, the sensor data includes an environmental model local map based on raw data received from the sensors (e.g., and subject matter expertise).

At block 436, processing logic determines, based on the sensor data, position map data (e.g., position global map). In some embodiments, the position map data is an indication of actual values based on the sensor data. In some embodiments, the position map data is generated using one or more of FIGS. 4D-E.

At block 438, processing logic causes motion planning data to be updated based on the position map data (e.g., causes block 432 of FIG. 4B by providing the position map data).

FIG. 4D is a method 400D for training a machine learning model (e.g., model 188 of FIG. 1A) for determining predictive data (e.g., predictive data 160 of FIG. 1A) to perform robot arm trajectory control, according to certain embodiments. Method 400D may be used by block 436 of FIG. 4C to determine position map data.

At block 440 of method 400D, the processing logic identifies historical sensor data (e.g., historical sensor data 144 of FIG. 1A). In some examples, the historical sensor data includes historical image data, historical force data, etc.

At block 442, the processing logic identifies historical position map data (e.g., historical position map data 154 of FIG. 1A). Each of the sets of the historical position map data corresponds to a respective set of historical sensor data. The historical position map data may be actual values (e.g., location, etc.) determined based on the historical sensor data (e.g., manually determined, verified via additional measurements, etc.).

At block 444, the processing logic trains a machine learning model using data input including the sets of historical sensor data and target output (e.g., target data) including the historical position map data to generate a trained machine learning model. In some embodiments, the trained machine learning model uses one or more of, Bayesian Probabilistic Learning, Bayesian Regression or Classification, Gaussian Process Regression or Classification, Bayesian Neural Networks, Neural Network Gaussian Processes, Gaussian Process Regressor (GPR), Bayesian Probabilistic Learning, Bayesian, Deep Belief Network, Gaussian Mixture Model, and/or the like). The trained machine learning model may be used in sequential (e.g., adaptive) design for local or global optimization to implement a type of Bayesian Optimization based on an acquisition function derived from uncertainty functions from these methods. The trained machine learning model may also be used to model or optimize computationally expensive methods (e.g., use data from complex plasma simulations to train and optimize a general model with minimal number of added simulations).

In some embodiments, the training of the machine learning model is unsupervised (e.g., clustering, graphs, etc.) and/or supervised (e.g., regression, classification, SFD augmentation, etc.).

In some embodiments, the processing logic further trains the machine learning model using additional data input and additional target output to update the trained machine learning model. Blocks 440-444 may repeat until the uncertainty of the trained machine learning model meets a threshold uncertainty.

FIG. 4E is a method 400E for using a trained machine learning model (e.g., model 188 of FIG. 1A) for robot arm trajectory control, according to certain embodiments. Method 400E may be used by block 436 of FIG. 4C to determine position map data.

Referring to FIG. 4E, at block 460 of method 400E, the processing logic identifies sensor data (e.g., see block 434 of FIG. 4C).

At block 462, processing logic provides the sensor data as input to a trained machine learning model (e.g., the trained machine learning model of block generated by FIG. 4D).

At block 464, processing logic obtains, from the trained machine learning model, output associated with predictive data (e.g., predictive data 160 of FIG. 1A).

At block 466, processing logic determines, based on the predictive data, position map data. This may be used for block 436 of FIG. 4C

In some embodiments, processing logic receives current data (e.g., current sensor data, current position map data) and causes the trained machine learning model to be updated or further trained (e.g., re-trained) with the current data (e.g., with data input including the current parameters and target output including the current performance data).

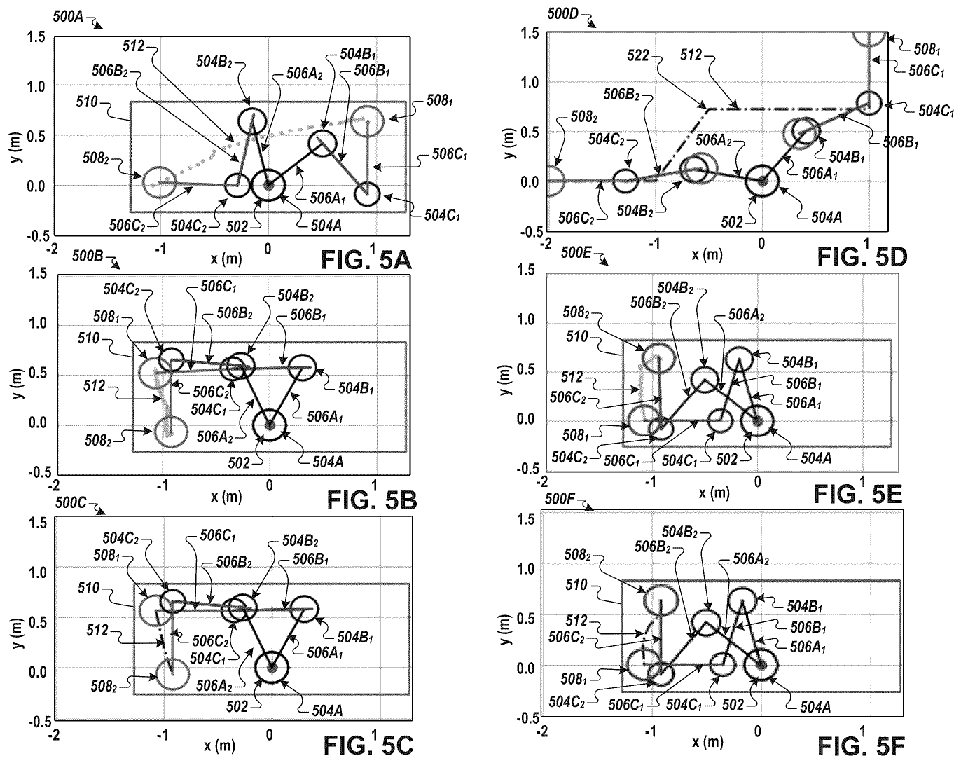

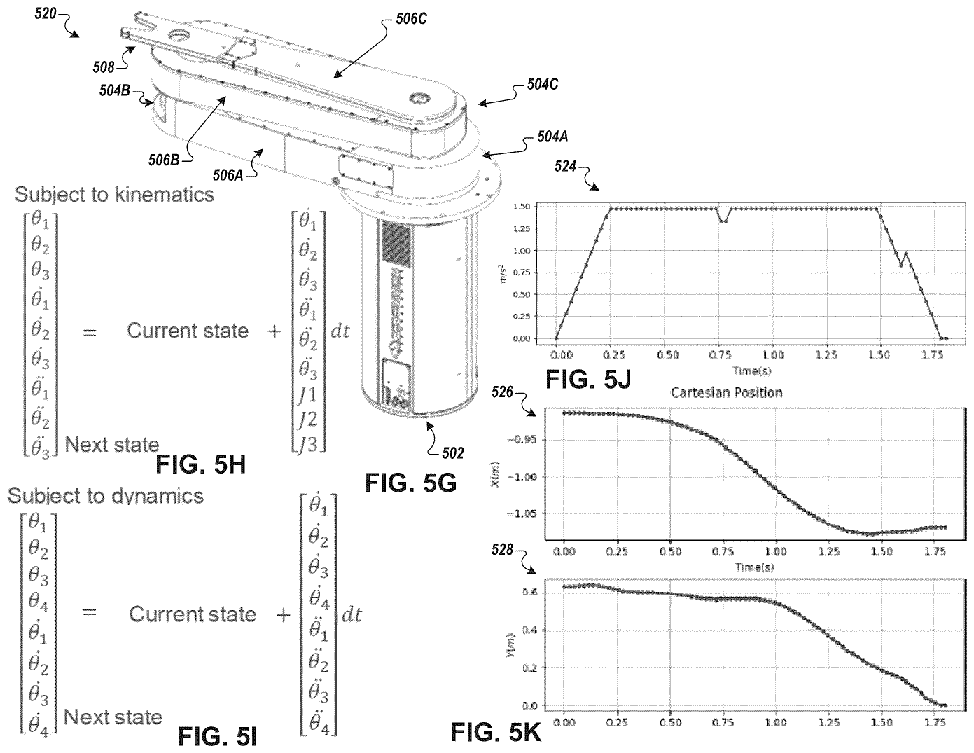

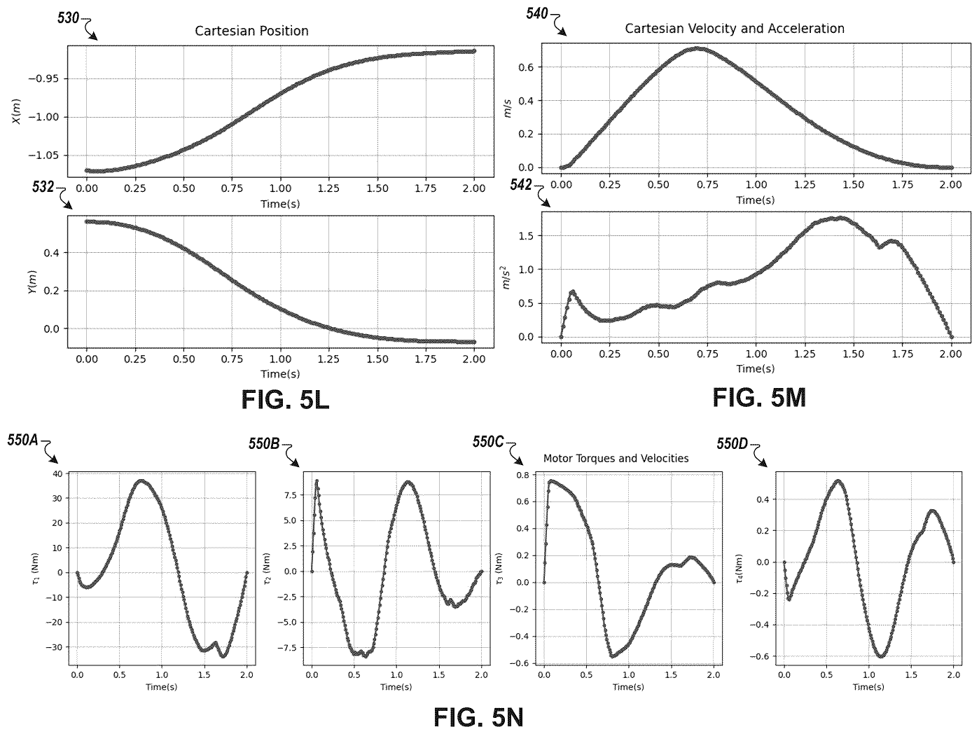

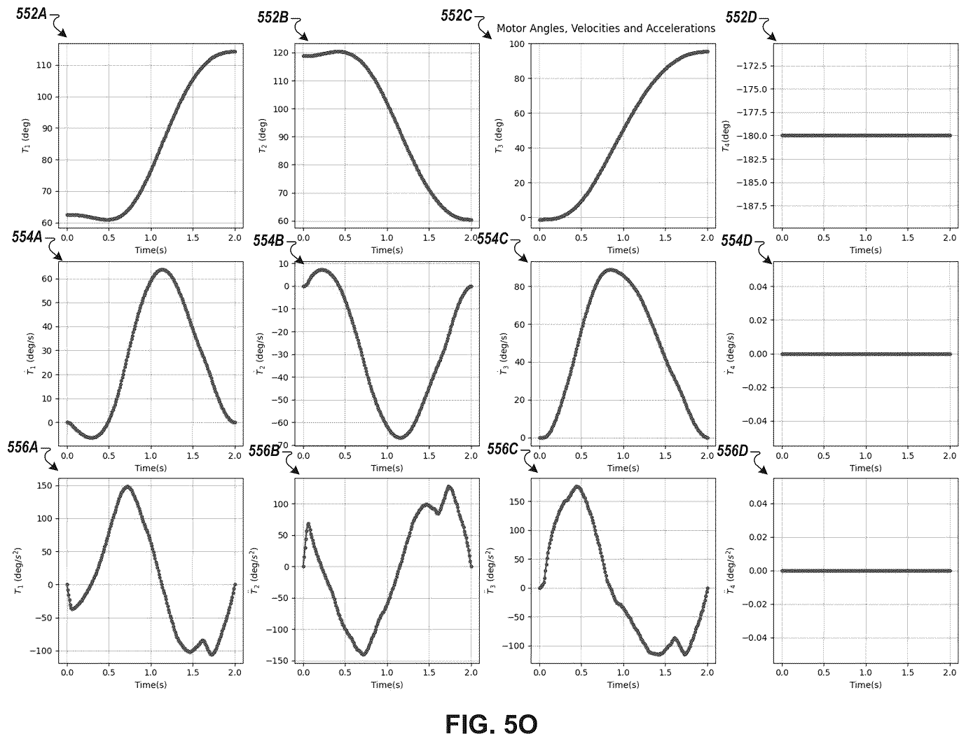

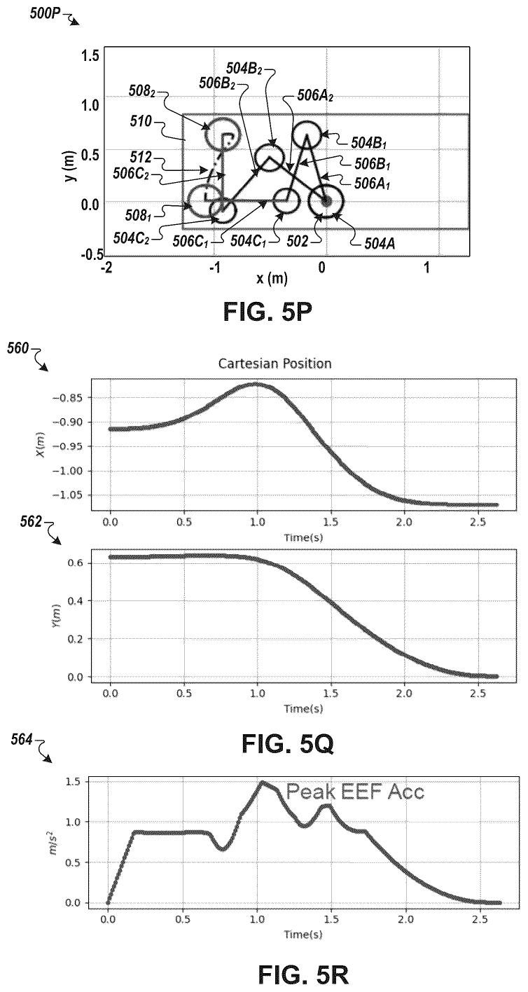

FIGS. 5A-R illustrate robot arm trajectory control, according to certain embodiments.

FIGS. 5A-F illustrate kinematic simulation 500A-F of robot arm trajectory control of a robot arm 520 and FIG. 5G illustrates a robot arm 520. Robot arm 520 may be robot arm 194 or robot arm 197 of FIG. 1C. Robot arm 520 may be controlled by device(s) 120 that execute one or more of trajectory component 122, motion planning component 123, trajectory execution component 124, actuation component 125, feature generation component 126, map building component 127, etc.

Referring to FIG. 5G, a robot arm 520 may have a base 502, joints 504, links 506, and an end effector 508. In some embodiments, the robot arm 520 includes joint 504A (e.g., disposed between base 502 and link 506A), joint 504B (e.g., disposed between link 506A and link 506B), and joint 504C (e.g., disposed between link 506B and link 506C). In some embodiments, the robot arm 520 includes link 506A (e.g., disposed between joint 504A and joint 504B), link 506B (e.g., disposed between joint 504B and joint 504C), and link 506C (e.g., disposed between joint 504C and end effector 508).

FIGS. 5A-F illustrate a first orientation of robot arm 520 disposed in a transfer chamber 510, a second orientation of the robot arm 520 disposed in the transfer chamber 510, and a trajectory 512 (e.g., path of end effector 508) from the first orientation to the second orientation.

The first orientation of robot arm 520 may include base 502, joint 504A, link 506A₁, joint 504B₁, link 506B₁, joint 504C₁, link 506C₁, and end effector 508₁ (e.g., that may be rotatably coupled to each other in that order).

The second orientation of robot arm 520 may include base 502, joint 504A, link 506A₂, joint 504B₂, link 506B₂, joint 504C₂, link 506C₂, and end effector 508₂ (e.g., that may be rotatably coupled to each other in that order).

Referring to FIG. 5A, kinematic simulation 500A may be a path planning (e.g., A* path planning) for SCARA, spindle joint (e.g., joint 504A), elbow joint (e.g., joint 504B), and wrist joint (e.g., joint 504C). The passive blade (e.g., end effector 508) may be a constraint and may point towards the elbow). Joint 504A may include jerk 1, joint 504B may include jerk 2, and joint 504C may include jerk 3.

Conventional robot arm control may use Inverse Kinematics and may suffer from singularity and may not be able to design continuous trajectory with minimum motor jerk and/or torque to have continuous velocity and/or acceleration.

The present disclosure may determine a trajectory 512 (e.g., may use an A* algorithm to determine A* path) to overcome the shortcomings of conventional solutions. The present disclosure may search (e.g., using A* algorithm that is a searching algorithm) for the shortest path between the initial and final state within the Cartesian and joint limit for collision avoidance.

The present disclosure (e.g., A* to determine A* path) may use a heuristic cost that gives priority to particular nodes (e.g., without exploring all possible paths).

Referring to FIG. 5B, kinematics simulation 500B may illustrate a trajectory 512 that is a discrete path planned by the present disclosure (e.g., A*) for collision avoidance.

Referring to FIG. 5C, kinematics simulation 500C may have a trajectory 512 that is a substantially smooth and continuous trajectory along a path (e.g., A* path) generated by non-linear optimization.

Referring to FIG. 5D, in some embodiments, kinematics simulation 500D may have a trajectory 512 that is determined by Cartesian Space Trajectory (e.g., s-curve). The robot arm 520 may stop at one or more via points 522 for collision avoidance.

In some embodiments, the present disclosure generates an s-curve for each motor. The robot arm 520 may stop or slow down at via points for collision avoidance which may cause longer move time and may not avoid an obstacle fully

Referring to FIG. 5E, in some embodiments illustrates a kinematics simulation of a discrete A*path.

Referring to FIG. 5F, in some embodiments illustrates a kinematics simulation of trajectory generated by nonlinear optimization (e.g., trajectory generated directly by nonlinear optimization). As shown in FIG. 5F, the path may become curvy to follow dynamic and kinematic constraint of the robot arm.

The acceleration and jerk constraint may be set to make robot EEF move along A* path (e.g., collision avoidance path within Acc and Jerk limit. Each robot motor may try to push infinite jerk to achieve the max EEF acceleration. FIGS. 5J-K may illustrate the acceleration and position graphs of the end effector (of FIG. 5E or 5F).

Referring to FIG. 5G, robot arm 520 may be controlled to perform one or more of the kinematics simulations 500A-F of FIGS. 5A-F. The present disclosure may be applied to robot arms 520 of different amount of joints 504, links 506, end effectors 508, etc. than those shown in FIG. 5G. The present disclosure may use non-linear optimization on industrial robots to provide robot arm trajectory control.

In some embodiments, the constraints include start state (e.g., first orientation), final state (e.g., second orientation), kinematics, etc.

In some embodiments, the boundary conditions include motor position, velocity, acceleration, jerk limit, blade (e.g., end effector 508) acceleration (e.g., less than 0.25 g (WW) (e.g., less than 8.04 feet per second squared).

The present disclosure may generate a smooth trajectory 512 to follow a path (e.g., A* path). The present disclosure may use non-linear optimization that uses an objective choices of one or more of move time, motor jerk, motor torque, shortest distance, etc. In some embodiments, the objective to minimize motor jerk (e.g., jerk at each joint) may use:

min∫₀^{tf}dist+J(t)₁²+J(t)₂²+J(t)₃²dt,

where dist is the minimum Euclidean distance between each state and all points (e.g., all the A* points).

Referring to FIGS. 5H-I, the present disclosure may use the formula of one or more of FIGS. 5H and/or 5I.

In some embodiments, the present disclosure includes passive blade planning (e.g., of the end effector) (e.g., increase A* algorithm to higher dimension, add passive blade planning into A* path planning).

In some embodiments, the present disclosure operates on a GPU (e.g., run optimization on GPU to reduce calculation time). In some embodiments, the present disclosure includes robot dynamic in the trajectory optimization. In some embodiments, the present disclosure uses rapidly exploring random tree (RRT) (e.g., that is used to search nonconvex, high-dimensional spaces by randomly building a space-filling tree) for planning in dimensions that exceed a threshold amount of dimensions. In some embodiments, the present disclosure runs non-linear optimization on the GPU to achieve real-time trajectory optimization.

The constraints (e.g., for non-linear optimization) may include a start state, a final state, kinematics, robot dynamics, and/or the like. The boundary conditions (e.g., for non-linear optimization) may include motor position, motor velocity, motor acceleration, motor torque limit, blade acceleration (e.g., less than 0.25 g (WW)), and/or the like.

The present disclosure may use an objective of minimizing motor torque using the following:

min∫₀^{tf}dist+T(t)₁²+T(t)₂²+T(t)₃²+T(t)₄²dt,

where dist is the minimum Euclidean distance between each state and all points (e.g., all the A* points).

In the equation shown in FIG. 5I, joint acceleration may be calculated by robot forward dynamics.

FIGS. 5J-O illustrate graphs associated with robot arm trajectory control (e.g., controlled by trajectory component 122 of FIG. 1A), according to certain embodiments.

Referring to FIG. 5J, graph 524 may illustrate acceleration of the end effector (m/s₂) over time (seconds). As shown in FIG. 5J, the change in acceleration in the present disclosure may be gradual over time (e.g., start and gradually increase and then gradually decrease before ending).

Referring to FIG. 5K, Cartesian position may be illustrated in graph 526 as x-location (e.g., x(m)) over time (e.g., seconds(s)) and in graph 528 as y-location (e.g., y(m)) over time (e.g., seconds(s)). As shown in FIG. 5K, the change in position in the present disclosure may be gradual over time.

Referring to FIG. 5L, Cartesian position may be illustrated in graph 530 as x-location (e.g., x(m)) over time (e.g., seconds(s)) and in graph 532 as y-location (e.g., y(m)) over time (e.g., seconds(s)). As shown in FIG. 5L, the change in position in the present disclosure may be gradual over time.

Referring to FIG. 5M, Cartesian velocity and acceleration may be illustrated in graph 540 as velocity (e.g., meters per second (m/s)) over time (e.g., seconds(s)) and in graph 542 as acceleration (e.g., meters per second squared (m/s²)) over time (e.g., seconds(s)). As shown in FIG. 5M, the change in velocity and/or acceleration over time in the present disclosure may increase from a start state to an intermediate state and then may decrease from the intermedia state to an end state (e.g., robot arm may not stop multiple times, robot arm may not slow down and then speed up).

Referring to FIG. 5N, motor torques and velocities may be illustrated for different joints (e.g., T₁, T₂, T₃, T₄, etc.). Graphs 550A-D illustrate Torque (e.g., Newton-meter (N*m)) over time (e.g., seconds(s)) for different joints (e.g., T₁, T₂, T₃, T₄).

Referring to FIG. 5O, motor angles, velocities and accelerations may be illustrated for different joints (e.g., T₁, T₂, T₃, T₄, etc.). Graphs 552A-D illustrate angle (e.g., degrees (deg)) over time (e.g., seconds(s)) for different joints (e.g., T₁, T₂, T₃, T₄).

Graphs 554A-D illustrate angular velocity (e.g., degrees per second (deg/s)) over time (e.g., seconds(s)) for different joints (e.g., T₁, T₂, T₃, T₄).

Graphs 556A-D illustrate angular acceleration (e.g., degrees per second squared (deg)) over time (e.g., seconds(s)) for different joints (e.g., T₁, T₂, T₃, T₄).

FIGS. 5P-R illustrate a trajectory (e.g., less aggressive trajectory) by generating an s-curve for each motor.

FIG. 5P illustrates a kinematics simulation of robot arm trajectory control. The trajectory 512 may be an s-shape. The robot end effector may reach an acceleration limit at a point in time and then may begin to slow down.

FIGS. 5Q-R may illustrate end effector acceleration and position plots.

Referring to FIG. 5Q, Cartesian position may be illustrated in graph 560 as x-location (e.g., x(m)) over time (e.g., seconds(s)) and in graph 562 as y-location (e.g., y(m)) over time (e.g., seconds(s)). As shown in FIG. 5Q, the change in position in the present disclosure may be gradual over time.

Referring to FIG. 5R, acceleration may be illustrated in graph 564 as acceleration (e.g., meters per second squared (m/s²)) over time (e.g., seconds(s)). As shown in FIG. 5R, the change in acceleration over time in the present disclosure may increase from a start state to an intermediate state and then may decrease from the intermedia state to an end state (e.g., robot arm may not stop multiple times, robot arm may substantially speed up until an intermediate state and then may substantially slow down).

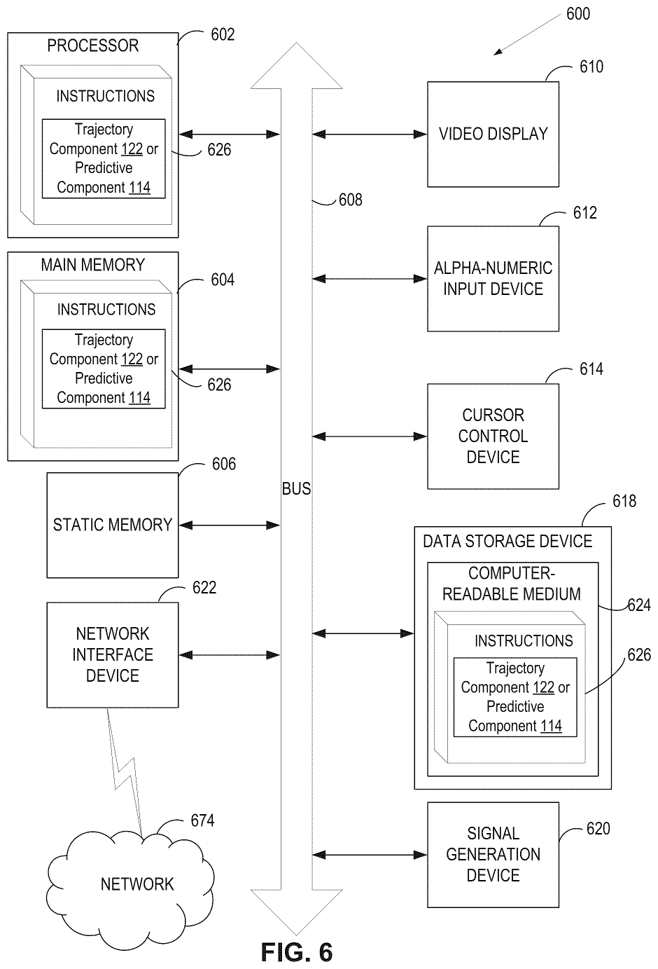

FIG. 6 is a block diagram illustrating a computer system 600, according to certain embodiments. In some embodiments, the computer system 600 is one or more of device(s) 120, predictive system 110, server machine 170, server machine 180, or predictive server 112.

In some embodiments, computer system 600 is connected (e.g., via a network, such as a Local Area Network (LAN), an intranet, an extranet, or the Internet) to other computer systems. In some embodiments, computer system 600 operates in the capacity of a server or a client computer in a client-server environment, or as a peer computer in a peer-to-peer or distributed network environment. In some embodiments, computer system 600 is provided by a personal computer (PC), a tablet PC, a Set-Top Box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 600 includes a processing device 602, a volatile memory 604 (e.g., Random Access Memory (RAM)), a non-volatile memory 606 (e.g., Read-Only Memory (ROM) or Electrically-Erasable Programmable ROM (EEPROM)), and a data storage device 616, which communicate with each other via a bus 608.

In some embodiments, processing device 602 is provided by one or more processors such as a general purpose processor (such as, for example, a Complex Instruction Set Computing (CISC) microprocessor, a Reduced Instruction Set Computing (RISC) microprocessor, a Very Long Instruction Word (VLIW) microprocessor, a microprocessor implementing other types of instruction sets, or a microprocessor implementing a combination of types of instruction sets) or a specialized processor (such as, for example, an Application Specific Integrated Circuit (ASIC), a Field Programmable Gate Array (FPGA), a Digital Signal Processor (DSP), or a network processor).

In some embodiments, computer system 600 further includes a network interface device 622 (e.g., coupled to network 674). In some embodiments, computer system 600 also includes a video display unit 610 (e.g., an LCD), an alphanumeric input device 612 (e.g., a keyboard), a cursor control device 614 (e.g., a mouse), and a signal generation device 620.

In some implementations, data storage device 616 includes a non-transitory computer-readable storage medium 624 on which store instructions 626 encoding any one or more of the methods or functions described herein, including instructions encoding components of FIG. 1A (e.g., trajectory component 122, predictive component 114, etc.) and for implementing methods described herein (e.g., one or more of methods 400A-E).

In some embodiments, instructions 626 also reside, completely or partially, within volatile memory 604 and/or within processing device 602 during execution thereof by computer system 600, hence, in some embodiments, volatile memory 604 and processing device 602 also constitute machine-readable storage media.

While computer-readable storage medium 624 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

In some embodiments, the methods, components, and features described herein are implemented by discrete hardware components or are integrated in the functionality of other hardware components such as ASICS, FPGAs, DSPs or similar devices. In some embodiments, the methods, components, and features are implemented by firmware modules or functional circuitry within hardware devices. In some embodiments, the methods, components, and features are implemented in any combination of hardware devices and computer program components, or in computer programs.

Unless specifically stated otherwise, terms such as “determining,” “generating,” “causing,” “updating,” “providing,” “receiving,” “training,” “identifying,” “obtaining,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. In some embodiments, the terms “first,” “second,” “third,” “fourth,” etc. as used herein are meant as labels to distinguish among different elements and do not have an ordinal meaning according to their numerical designation.

Examples described herein also relate to an apparatus for performing the methods described herein. In some embodiments, this apparatus is specially constructed for performing the methods described herein, or includes a general purpose computer system selectively programmed by a computer program stored in the computer system. Such a computer program is stored in a computer-readable tangible storage medium.

The methods and illustrative examples described herein are not inherently related to any particular computer or other apparatus. In some embodiments, various general purpose systems are used in accordance with the teachings described herein. In some embodiments, a more specialized apparatus is constructed to perform methods described herein and/or each of their individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

1. A method comprising:
identifying a sequence of robot configurations associated with processing a plurality of substrates;
generating motion planning data comprising corresponding velocity data and corresponding acceleration data for each portion of a trajectory associated with the processing of the plurality of substrates; and
causing a robot arm to be actuated based on the motion planning data.

2. The method of claim 1, wherein each robot configuration of the sequence of robot configurations comprises a corresponding joint angle for each joint of a plurality of joints of the robot arm.

3. The method of claim 1 further comprising identifying a plurality of locations associated with the processing of the plurality of substrates, wherein the sequence of robot configurations are based on the plurality of locations.

4. The method of claim 3, wherein the robot arm is disposed in a transfer chamber, and wherein the plurality of locations comprise a first location of a load lock coupled to the transfer chamber and a second location of a processing chamber coupled to the transfer chamber.

5. The method of claim 1, wherein the generating of the motion planning data comprises:
identifying joint limits of the robot arm; and
minimizing distance of the trajectory between corresponding robot configurations of the sequence of robot configurations based on the joint limits of the robot arm.

6. The method of claim 1, wherein the generating of the motion planning data is based on constraint data comprising an initial robot configuration, a final robot configuration, kinematic constraints of the robot arm, and robot dynamics of the robot arm.

7. The method of claim 1, wherein the generating of the motion planning data is via non-linear optimization using a graphics processing unit (GPU).

8. The method of claim 1 further comprising:
identifying position map data that is based on sensor data associated with actuation of the robot arm; and
updating the motion planning data based on the position map data.

9. The method of claim 8, wherein the position map data is associated with output of a trained machine learning model responsive to providing the sensor data as input to the trained machine learning model.

10. The method of claim 9, wherein the trained machine learning model is trained based on data input comprising historical sensor data and target output comprising historical position map data.

11. A non-transitory computer-readable storage medium storing instructions which, when executed, cause a processing device to perform operations comprising:
identifying a sequence of robot configurations associated with processing a plurality of substrates;
generating motion planning data comprising corresponding velocity data and corresponding acceleration data for each portion of a trajectory associated with the processing of the plurality of substrates; and
causing a robot arm to be actuated based on the motion planning data.

12. The non-transitory computer-readable storage medium of claim 11, wherein each robot configuration of the sequence of robot configurations comprises a corresponding joint angle for each joint of a plurality of joints of the robot arm.

13. The non-transitory computer-readable storage medium of claim 11 further comprising identifying a plurality of locations associated with the processing of the plurality of substrates, wherein the sequence of robot configurations are based on the plurality of locations, wherein the robot arm is disposed in a transfer chamber, and wherein the plurality of locations comprise a first location of a load lock coupled to the transfer chamber and a second location of a processing chamber coupled to the transfer chamber.

14. The non-transitory computer-readable storage medium of claim 11, wherein the generating of the motion planning data comprises:
identifying joint limits of the robot arm; and
minimizing distance of the trajectory between corresponding robot configurations of the sequence of robot configurations based on the joint limits of the robot arm.

15. The non-transitory computer-readable storage medium of claim 11, wherein the generating of the motion planning data is based on constraint data comprising an initial robot configuration, a final robot configuration, kinematic constraints of the robot arm, and robot dynamics of the robot arm.

16. A system comprising:
a memory; and
a processing device coupled to the memory, the processing device to:
identify a sequence of robot configurations associated with processing a plurality of substrates;
generate motion planning data comprising corresponding velocity data and corresponding acceleration data for each portion of a trajectory associated with the processing of the plurality of substrates; and
cause a robot arm to be actuated based on the motion planning data.

17. The system of claim 16, wherein each robot configuration of the sequence of robot configurations comprises a corresponding joint angle for each joint of a plurality of joints of the robot arm.

18. The system of claim 16 further comprising identifying a plurality of locations associated with the processing of the plurality of substrates, wherein the sequence of robot configurations are based on the plurality of locations, wherein the robot arm is disposed in a transfer chamber, and wherein the plurality of locations comprise a first location of a load lock coupled to the transfer chamber and a second location of a processing chamber coupled to the transfer chamber.

19. The system of claim 16, wherein to generate of the motion planning data, the processing device is to:
identifying joint limits of the robot arm; and
minimizing distance of the trajectory between corresponding robot configurations of the sequence of robot configurations based on the joint limits of the robot arm.

20. The system of claim 18, wherein the processing device is to generate the motion planning data based on constraint data comprising an initial robot configuration, a final robot configuration, kinematic constraints of the robot arm, and robot dynamics of the robot arm.
